(19) United States
(12) Patent Application Publication
(10) Pub. No.: US 2020/0380322 A1
(43) Pub. Date: Dec. 3, 2020

(54) AUTHENTICATION METHOD AND SYSTEM USING A TWO-DIMENSIONAL BARCODE SEQUENCE

(71) Applicant: Lubn Inc., Bellevue, WA (US)

(72) Inventors: Chiu-Wan LI, Bellevue, WA (US); Yuan-Chou CHUNG, Bellevue, WA (US)

(21) Appl. No.: 16/886,468

(22) Filed: May 28, 2020

Related U.S. Application Data
(60) Provisional application No. 62/853,251, filed on May 28, 2019.

(51) Int. Cl. G06K 19/06; G06K 7/14

(52) U.S. Cl. CPC G06K 19/06046; G06K 2019/06253; G06K 19/06037; G06K 7/1417

(57) ABSTRACT

An authentication method and an authentication system are provided. The authentication system includes a display device and an authentication device. In the authentication method, at first, two-dimensional (2D) barcodes and a time sequence of the two-dimensional barcodes are provided in accordance with an authentication code. Then, the two-dimensional barcodes are displayed in accordance with the time sequence by using the display device. Thereafter, the two-dimensional barcodes displayed on the display device are captured by the authentication device. Then, a decoding process is performed in accordance with the two-dimensional barcodes and the time sequence to obtain the authentication code. Thereafter, an authentication process is performed by using the authentication code.

### RELATED APPLICATION

This application claims priority to U.S. Provisional Application Ser. No. 62/853,251, filed May 28, 2019, which is herein incorporated by reference in its entirety.

### BACKGROUND

### Field of Invention

The embodiments of the present invention relate to an authentication method and an authentication system.

### Description of Related Art

Authentication technologies are applied in various fields, such as a QR code boarding pass, a QR code ticket pass, a smart key box and a door security system for user identification. For example, the smart key box may include an authentication device. When a user uses a smart phone to display a QR code, the authentication device of the smart key box captures the QR code displayed by the smart phone and determines whether the QR code is correct. When the QR code is correct, the smart key box is unlocked to provide a door key to the user. However, the QR code may be copied (stolen) by other people when the QR code is displayed.

### SUMMARY

An object of the present invention is to provide an authentication method and an authentication system using a two-dimensional barcode sequence. Plural two-dimensional barcodes are displayed in a predetermined time sequence to avoid being copied/stolen.

According to the object of the present invention, the authentication method includes: providing a plurality of two-dimensional (2D) barcodes and a time sequence of the two-dimensional barcodes in accordance with an authentication code; displaying the two-dimensional barcodes in accordance with the time sequence by using a display device; capturing the two-dimensional barcodes displayed on the display device by using an image capturing component; performing a decoding process in accordance with the two-dimensional barcodes and the time sequence to obtain the authentication code; and performing an authentication process by using the authentication code.

In some embodiments, the time sequence of the two-dimensional barcodes comprises an order for displaying the two-dimensional barcodes.

In some embodiments, the time sequence of the two-dimensional barcodes further comprises at least one time interval between the two-dimensional barcodes.

In some embodiments, the authentication method further includes: providing at least one dummy pattern; and displaying the least one dummy pattern by using the display device before or after one of the two-dimensional barcodes is displayed by the display device.

In some embodiments, the display device is a smart phone or an e-ink badge.

According to the object of the present invention, the authentication system includes a display device and an authentication device. The display device is configured to display a plurality of two-dimensional barcodes in accordance with a time sequence. The authentication device includes an image capturing component and a controller. The image capturing component is configured to capture the two-dimensional barcodes displayed by the display device. The controller is electrically connected to the image capturing component, wherein the controller is configured to perform a decoding process in accordance with the two-dimensional barcodes and the time sequence to obtain an authentication code, and to perform an authentication process by using the authentication code.

In some embodiments, the time sequence of the two-dimensional barcodes comprises an order for displaying the two-dimensional barcodes.

In some embodiments, the time sequence of the two-dimensional barcodes further comprises at least one time interval between the two-dimensional barcodes.

In some embodiments, the authentication system includes a control center configured to generate a video in accordance with the authentication code, and to transmit the video to the display device, wherein the video comprises the two-dimensional barcodes arranged in the time sequence.

In some embodiments, the video further comprises at least one dummy pattern arranged before or after one of the two-dimensional barcodes, and the display device is further configured to display the at least one dummy pattern.

In some embodiments, the authentication system includes a control center configured to generate a plurality of two-dimensional barcodes and a time sequence of the two-dimensional barcodes in accordance with the authentication code and to transmit the two-dimensional barcodes and the time sequence to the display device.

In some embodiments, the display device is further configured to display at least one dummy pattern before or after one of the two-dimensional barcodes is displayed by the display device.

In some embodiments, the display device is a smart phone or an e-ink badge.

In order to make the above features and advantages of the present disclosure more apparent, the following embodiments are described in detail with reference to the accompanying drawings.

### BRIEF DESCRIPTION OF THE DRAWINGS

Aspects of the present disclosure are better understood from the following detailed description in conjunction with the accompanying figures. It is noted that in accordance with the standard practice in the industry, various features are not drawn to scale. In fact, the dimensions of the various features can be arbitrarily increased or reduced for clarity of discussion.

FIG. 1 is a functional diagram showing an authentication system in accordance with an embodiment of the present invention.

FIG. 2 is a schematic diagram showing the two-dimensional barcodes displayed on the display device in accordance with an embodiment of the present invention.

FIG. 3 is a schematic diagram showing the two-dimensional barcodes displayed on the display device in accordance with another embodiment of the present invention.

FIG. 4 is a functional diagram showing an authentication system in accordance with some embodiments of the present invention.

FIG. 5A to FIG. 5C are schematic diagrams showing the two-dimensional barcodes displayed on the display device in accordance with some embodiments of the present invention.

FIG. 6 is a flow chart showing an authentication method in accordance with some embodiments of the present invention.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. In addition, the terms “first”, “second”, and the like, as used herein, are not intended to mean a sequence or order, and are merely used to distinguish elements or operations described in the same technical terms.

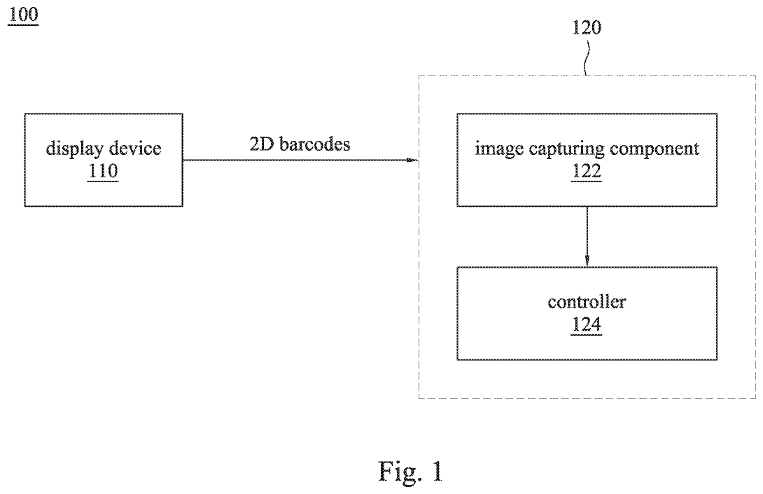

Referring to FIG. 1, FIG. 1 is a functional diagram showing an authentication system 100 in accordance with an embodiment of the present invention. The authentication system 100 includes a display device 110 and an authentication device 120. In this embodiment, the display device 110 is a smart phone held by a client, and the authentication device 120 is disposed in a smart key box for client authentication. However, embodiments of the present invention are not limited thereto. In some embodiments, the display device 110 is an e-ink badge. The display device 110 is configured to display two-dimensional barcodes in accordance with a time sequence, and the authentication device 120 is configured to capture the two-dimensional barcodes displayed on the display device 110 to achieve the client authentication. In this embodiment, the two-dimensional barcodes are QR codes, but embodiments of the present invention are not limited thereto.

In accordance with an embodiment of the present invent, the display device 110 may download an application (App) for the client authentication. The application is used to provide the two-dimensional barcodes and a time sequence of the two-dimensional barcodes in accordance with an authentication code corresponding to the client, in which the time sequence of the two-dimensional barcodes includes an order for displaying the two-dimensional barcodes. For example, when the client wants to get the key in the smart key box to open a door, the client controls the display device 110 to show the two-dimensional barcodes to the authentication device 120. Then, the authentication device 120 performs a decoding process and an authentication process in accordance with the two-dimensional barcodes.

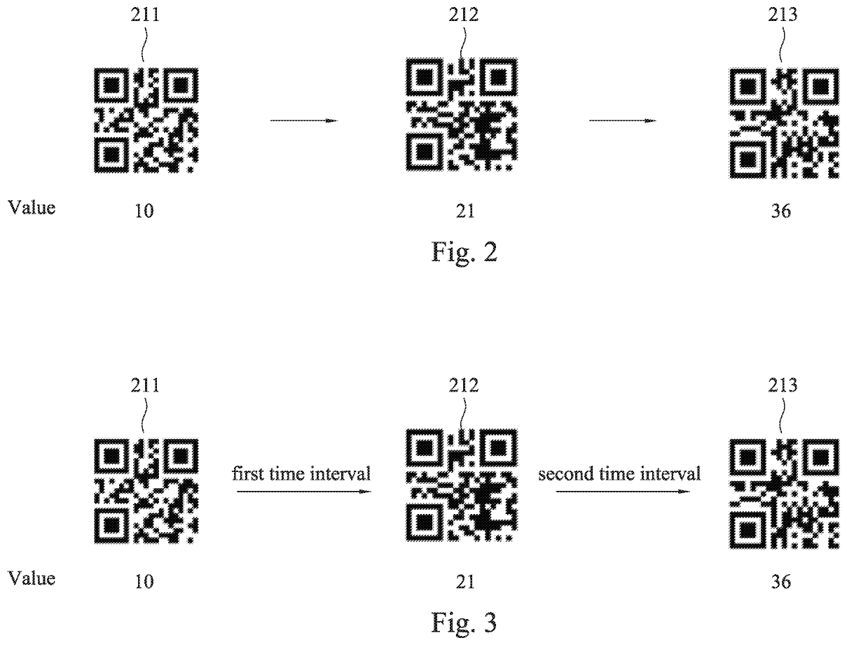

Referring to FIG. 2, FIG. 2 is a schematic diagram showing the two-dimensional barcodes displayed on the display device 110 in accordance with an embodiment of the present invention. In this embodiment, the authentication code corresponding to the client is “102136”, and the application generates a first two-dimensional barcode 211, a second two-dimensional barcode 212, a third two-dimensional barcode 213 and a time sequence thereof to represent “102136”.

For example, the first two-dimensional barcode 211 represents “10”, the second two-dimensional barcode 212 represents “21”, the third two-dimensional barcode 213 represents “36”, and the order for displaying the two-dimensional barcodes is “211-212-213”. When the display device 110 is controlled to display the two-dimensional barcodes, the first two-dimensional barcode 211 is firstly displayed on the display device 110, and then the second two-dimensional barcode 212 is displayed on the display device 110, and then the third two-dimensional barcode 213 is displayed on the display device 110.

Returning to FIG. 1, the authentication device 120 includes an image capturing component 122 and a controller 124. The image capturing component 122 is configured to capture the two-dimensional barcodes displayed by the display device 110, and the controller 124 is electrically connected to the image capturing component to receive the two-dimensional barcodes and to perform the decoding process and the authentication process.

For example, after receiving the first two-dimensional barcode 211, the second two-dimensional barcode 212 and the third two-dimensional barcode 213, the controller 124 performs the decoding process in accordance with the first two-dimensional barcode 211, the second two-dimensional barcode 212, the third two-dimensional barcode 213 and the time sequence thereof to obtain the authentication code. Because the time sequence (display order) of the first two-dimensional barcode 211, the second two-dimensional barcode 212, the third two-dimensional barcode 213 is “211-212-213”, the first two-dimensional barcode 211 is firstly received by the authentication device 120, the second two-dimensional barcode 212 is received by the authentication device 200 after the two-dimensional barcode 211 is received, and the third two-dimensional barcode 213 is received by the authentication device 200 after the second two-dimensional barcode 212 is received. Therefore, the controller 124 obtains “10”, “21” and “36”, and combines “10”, “21” and “36” in accordance with the time sequence of the first two-dimensional barcode 211, the second two-dimensional barcode 212 and third two-dimensional barcode 213 to obtain the authentication code “102136”.

After obtaining the authentication code “102136”, the controller 124 performs the authentication process to check whether the authentication code is correct. For example, the controller 124 may store a list of qualified identifications, and the qualified identifications correspond to plural qualified codes in a one-to-one manner. When the authentication code is the same as one of the qualified codes, the controller 124 determines that the authentication code is correct and controls the smart key box to release the key to the client.

In some embodiments, the controller 124 may unlock the door instead of releasing the key when the controller 124 determines that the authentication code is correct.

In some embodiments, the authentication device 120 is disposed in an electric device having no network communication device. When the controller 124 determines that the authentication code is correct, the controller 124 may synchronize the data of the electric device with the data of the display device 110, or synchronize the data of the display device 110 with the data of the electric device. The data synchronization may include time synchronization, user information synchronization, and setting values synchronization. However, embodiments of the present invention are not limited thereto.

In some embodiments, the authentication device 120 is disposed in a smart door lock. The controller 124 may perform mode switching when the controller 124 determines that the authentication code is correct. For example, when the authentication code is the same as a first one of the qualified codes, the controller 124 controls the smart door lock to enter a first operation mode (for example, an offline mode). For another example, when the authentication code is the same as a second one of the qualified codes, the controller 124 controls the smart door lock to enter a second operation mode (for example, an online mode). For still another example, when the authentication code is the same as a third one of the qualified codes, the controller 124 controls the smart door lock to enter a third operation mode (for example, a manual mode).

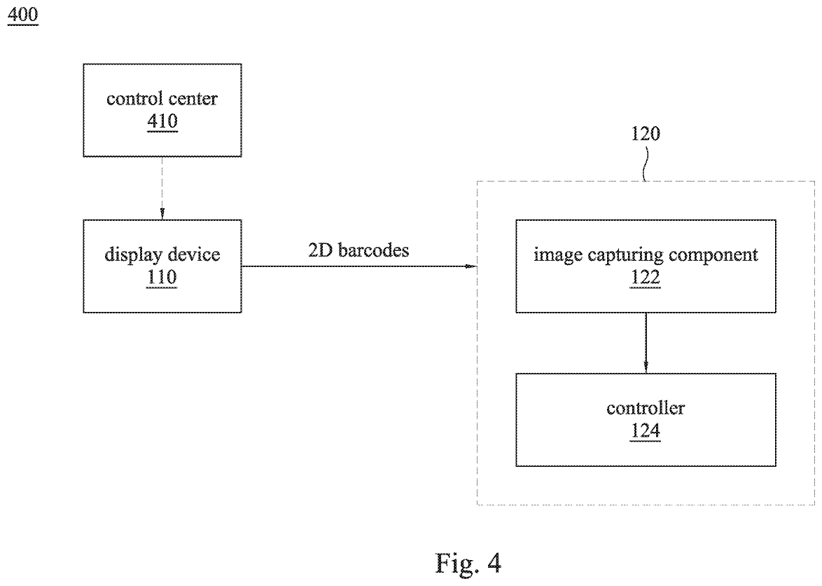

Referring to FIG. 3, FIG. 3 is a schematic diagram showing the two-dimensional barcodes displayed on the display device 110 in accordance with another embodiment of the present invention. In this embodiment, the time sequence provided by the application includes the order for displaying the two-dimensional barcodes and at least one time interval between the two-dimensional barcodes. As shown in FIG. 3, after the first two-dimensional barcode 211 is displayed and a first time interval passes, the second two-dimensional barcode 212 is displayed. Similarly, after the second two-dimensional barcode 212 is displayed and a second time interval passes, the third two-dimensional barcode 213 is displayed.

Regarding the decoding process performed by the controller 124, the controller 124 determines whether the at least one time interval between the two-dimensional barcodes is qualified. For example, the controller 124 determines whether the first time interval is greater than a time threshold. When the first time interval is greater than the time threshold, the first time interval is qualified. Similarly, the controller 124 determines whether the second time interval is greater than the time threshold. When the second time interval is greater than the time threshold, the second time interval is qualified. When the first time interval and the second time interval are qualified, the controller 124 performs the authentication process to check whether the authentication code “102136” is correct.

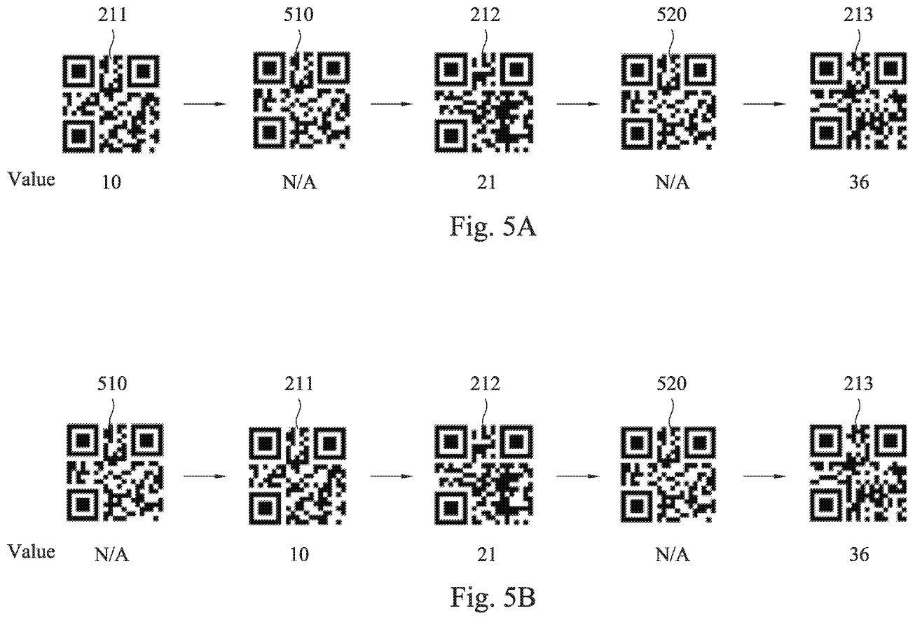

Referring to FIG. 4, FIG. 4 is a functional diagram showing an authentication system 400 in accordance with some embodiments of the present invention. The authentication system 400 is similar to the authentication system 100, but the difference is in that authentication system 400 further includes a control center 410. In this embodiment, the control center 410 is configured to provide the two-dimensional barcodes and the time sequence of the two-dimensional barcodes to the display device 110, and thus the display device 110 does not need to download the application to obtain the two-dimensional barcodes and the time sequence of the two-dimensional barcodes.

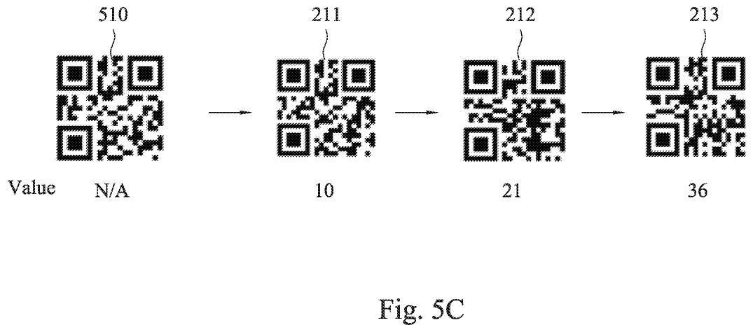

Referring to FIG. 5A to FIG. 5C, FIG. 5A to FIG. 5C are schematic diagrams showing the two-dimensional barcodes displayed on the display device 110 in accordance with some embodiments of the present invention. In this embodiment, at least one dummy pattern are provided and inserted in to the sequence of the two-dimensional barcodes. For example, a first dummy pattern 510 and a second dummy pattern 520 are provided, and at least one of the first dummy pattern 510 and the second dummy pattern 520 is randomly inserted into the sequence of the first two-dimensional barcode 211, the second two-dimensional barcode 212 and the third two-dimensional barcode 213. The at least one dummy pattern can be provided by the control center 410 or the application download by the display device 110.

In some embodiments, as shown in FIG. 5A, the first dummy pattern 510 is displayed before the second two-dimensional barcode 212 is displayed and after the first two-dimensional barcode 211 is displayed, and the second dummy pattern 520 is displayed before the third two-dimensional barcode 213 is displayed and after the second two-dimensional barcode 212 is displayed.

In some embodiments, as shown in FIG. 5B, the first dummy pattern 510 is displayed before the first two-dimensional barcode 211 is displayed, and the second dummy pattern 520 is displayed before the third two-dimensional barcode 213 is displayed and after the second two-dimensional barcode 212 is displayed.

In some embodiments, as shown in FIG. 5C, the first dummy pattern 510 is displayed before the first two-dimensional barcode 211 is displayed, and the second dummy pattern 420 is not used.

Regarding the decoding process performed by the controller 124, the first dummy pattern 510 and the second dummy pattern 520 are ignored when the decoding process is performed. For example, the controller 124 may store plural dummy patterns including the first dummy pattern 510 and the second dummy pattern 520. Therefore, when receiving the first dummy pattern 510 and the second dummy pattern 520, the controller 124 can recognize the first dummy pattern 510 and the second dummy pattern 520, and then ignore the first dummy pattern 510 and the second dummy pattern 520.

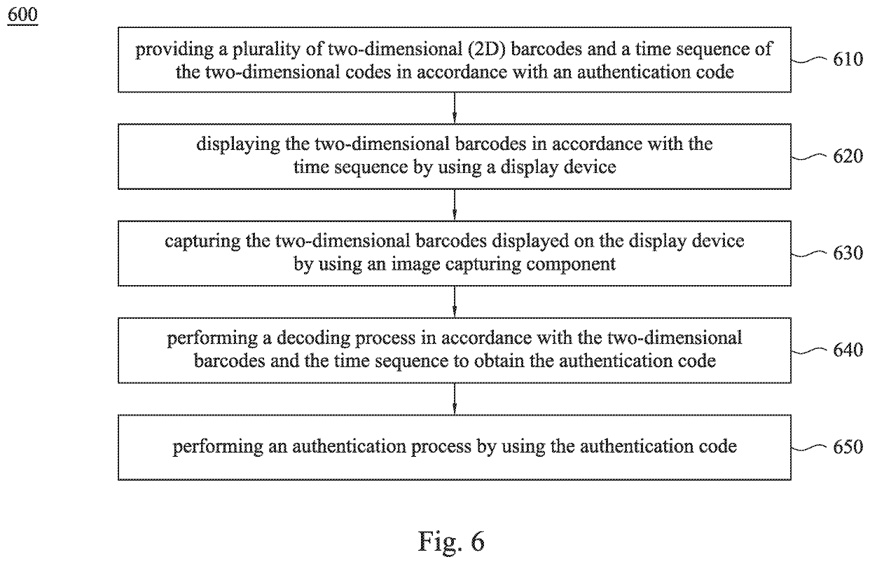

Referring to FIG. 6, FIG. 6 is a flow chart showing an authentication method 600 in accordance with some embodiments of the present invention. In the authentication method 600, at first, step 610 is performed to provide the two-dimensional barcodes (such as first two-dimensional barcode 211, the second two-dimensional barcode 212 and the third two-dimensional barcode 213) and a time sequence of the two-dimensional barcodes in accordance with an authentication code. Then, step 620 is performed to display the two-dimensional barcodes in accordance with the time sequence by using the display device 110. Thereafter, step 630 is performed to capture the two-dimensional barcodes displayed on the display device 110 by using the image capturing component 122. Then, step 640 is performed to perform the decoding process in accordance with the two-dimensional barcodes and the time sequence to obtain the authentication code. Thereafter, step 650 is performed to perform the authentication process by using the authentication code.

In some embodiments, the authentication method 600 further includes providing at least one dummy pattern (such as the first dummy pattern 510) and displaying the least one dummy pattern by using the display device 110 before or after one of the two-dimensional barcodes is displayed by the display device 110.

The features of several embodiments are outlined above, so those skilled in the art can better understand the aspects of the present disclosure. Those skilled in the art will appreciate that the present disclosure can be readily utilized as a basis for designing or modifying other processes and structures, thereby achieving the same objectives and/or achieving the same advantages as the embodiments described herein. Those skilled in the art should also understand that these equivalent constructions do not depart from the spirit and scope of the present disclosure, and they can make various changes, substitutions and alteration without departing from the spirit and scope of the present disclosure.

What is claimed is:

1. An authentication method, comprising:
providing a plurality of two-dimensional (2D) barcodes and a time sequence of the two-dimensional barcodes in accordance with an authentication code;
displaying the two-dimensional barcodes in accordance with the time sequence by using a display device;
capturing the two-dimensional barcodes displayed on the display device by using an image capturing component;
performing a decoding process in accordance with the two-dimensional barcodes and the time sequence to obtain the authentication code; and
performing an authentication process by using the authentication code.

2. The authentication method of claim 1, wherein the time sequence of the two-dimensional barcodes comprises an order for displaying the two-dimensional barcodes.

3. The authentication method of claim 2, wherein the time sequence of the two-dimensional barcodes further comprises at least one time interval between the two-dimensional barcodes.

4. The authentication method of claim 1, further comprising:
providing at least one dummy pattern; and
displaying the least one dummy pattern by using the display device before or after one of the two-dimensional barcodes is displayed by the display device.

5. The authentication method of claim 1, wherein the display device is a smart phone or an e-ink badge.

6. An authentication system, comprising:
a display device configured to display a plurality of two-dimensional barcodes in accordance with a time sequence; and
an authentication device comprising:
an image capturing component configured to capture the two-dimensional barcodes displayed by the display device;
a controller electrically connected to the image capturing component, wherein the controller is configured to:
perform a decoding process in accordance with the two-dimensional barcodes and the time sequence to obtain an authentication code; and
perform an authentication process by using the authentication code.

7. The authentication system of claim 6, wherein the time sequence of the two-dimensional barcodes comprises an order for displaying the two-dimensional barcodes.

8. The authentication system of claim 7, wherein the time sequence of the two-dimensional barcodes further comprises at least one time interval between the two-dimensional barcodes.

9. The authentication system of claim 6, further comprises:
a control center configured to:
generate a video in accordance with the authentication code, wherein the video comprises the two-dimensional barcodes arranged in the time sequence; and
transmit the video to the display device.

10. The authentication system of claim 9, wherein the video further comprises at least one dummy pattern arranged before or after one of the two-dimensional barcodes, and the display device is further configured to display the at least one dummy pattern.

11. The authentication system of claim 6, further comprises:
a control center configured to:
generate a plurality of two-dimensional barcodes and a time sequence of the two-dimensional barcodes in accordance with the authentication code; and
transmit the two-dimensional barcodes and the time sequence to the display device.

12. The authentication system of claim 11, wherein the display device is further configured to display at least one dummy pattern before or after one of the two-dimensional barcodes is displayed by the display device.

13. The authentication system of claim 6, wherein the display device is a smart phone or an e-ink badge.
